(19) United States
(12) Patent Application Publication
(10) Pub. No.: US 2012/0281445 A1
(43) Pub. Date: Nov. 8, 2012

(54) TRANSFORMER UNIT

(75) Inventors: Hideaki Moriya, Shiga (JP); Nobuo Shirokawa, Shiga (JP); Haruo Suenaga, Osaka (JP); Manabu Kinoshita, Shiga (JP)

(73) Assignee: PANASONIC CORPORATION, Kadoma-shi, Osaka (JP)

(21) Appl. No.: 13/520,847

(22) PCT Filed: Jan. 6, 2011
(86) PCT No.: PCT/JP2011/000029

§ 371 Date: Jul. 6, 2012

(30) Foreign Application Priority Data
Jan. 7, 2010 (JP) 2010-001683

(51) Int. Cl. H02M 7/04

(52) U.S. Cl. 363/61

(57) ABSTRACT

A transformer unit includes: a transformer which is mounted on a printed board, and which includes a bobbin around which at least a primary winding and a secondary winding are wound and a core which is inserted into a center of the bobbin; and a component holding portion configured to hold a component at an outer peripheral portion except for a mount side to be mounted on the printed board. The transformer unit further includes a voltage doubler rectifying circuit which is provided at the component holding portion and which is configured to rectify a high-frequency high voltage applied from the secondary winding. The secondary winding is connected to a lead terminal of a high-voltage component constituting the voltage doubler rectifying circuit via tension absorbing means provided at the bobbin.

### TECHNICAL FIELD

The present invention relates to a transformer unit to be used in an inverter-type high-frequency heating device, etc.

### BACKGROUND ART

Small-sized and light-weighted power supplies have been demanded as the power supplies to be used in high-frequency heating devices such as kitchen microwaves used in standard homes, from the view point of the nature thereof. In other words, the size of a machine room in which the power supply is housed has been demanded to be small in order to facilitate the portability and enlarge a heating chamber. To this end, the reduction in size, weight and cost have been advanced by performing the switching operation of the power supply, and hence inverter-type power supplies are used mainly at the moment

An example of the high-frequency heating device of a related art containing the inverter-type power supply will be explained with reference to a circuit diagram shown in FIG. 4. FIG. 4 shows an example of the circuit diagram of the high-frequency heating device of the related art.

The output of a commercial power supply 1 is rectified and converted into a DC voltage by a rectifier 2. This DC voltage is applied to an inverter resonance circuit 5 formed by a capacitor 4, a primary winding 13 and a semiconductor switching element 3 via a filter circuit 11 formed by a choke coil 9 and a capacitor 10. In the inverter resonance circuit 5, the semiconductor switching element 3 performs the switching operation at the frequency in a range from 20 to 45 KHz to thereby generate a high-frequency AC voltage. Since the primary winding 13 also serves as the primary winding of a high-voltage transformer 6, the high-frequency AC voltage generated at the primary winding 13 is boosted to a high voltage at the secondary winding 14 of the high-voltage transformer 6. The high voltage boosted at the secondary winding 14 of the high-voltage transformer 6 is rectified into a DC high voltage by a voltage doubler rectifying circuit 7.

A control circuit unit 20 generates, reflecting input current information obtained from a current transformer 12, a signal for obtaining a desired high-frequency output and supplies the signal to the semiconductor switching element 3 to thereby drive the semiconductor switching element 3. A command signal for determining the desired high-frequency output is applied to the control circuit unit 20 from a microcomputer 19 of the outside via an insulation interface (not shown) such as a photo coupler. As a result, the high-frequency output such as 1,000 W, 800 W or 600 W can be obtained as the desired high-frequency output. The electrical components constitute an inverter-type power supply 18 (see FIG. 4).

The DC high voltage rectified by the voltage doubler rectifying circuit 7 is applied between the anode 17 and the cathode 16 of a magnetron 8. The high-voltage transformer 6 is provided with an auxiliary secondary winding. The auxiliary secondary winding constitutes a heating current supply line 15 for supplying a heating current as supply of electrical power to the cathode 16 of the magnetron 8. When the cathode 16 is supplied with the electrical power, the temperature thereof increases. Further, in this state, when the high voltage is applied between the anode 17 and the cathode 16, the magnetron 8 oscillates to generates a microwave. The microwave generated from the magnetron 8 is irradiated on a heated subject such as food housed within the heating chamber to thereby perform dielectric heat cooking.

In recent years, there has been proposed a transformer unit (integration of the high-voltage transformer 6 and the voltage doubler rectifying circuit 7), as an ultimate configuration for miniaturization, which is configured by disposing the components of the voltage doubler rectifying circuit at the side surface of the transformer for the inverter-type power supply. In this configuration, the size of a board is ultimately miniaturized. An example of the transformer unit configured in this manner is described in a patent Document 1, for example.

### RELATED ART DOCUMENTS

### Patent Documents

Patent Document 1: JP-A-2004-304142

### SUMMARY OF THE INVENTION

### Problem to be Solved by the Invention

However, the configuration of the related art has the following problems. That is, since it is required to dispose the components at the side surface of the transformer for the inverter-type power supply and to wind the secondary winding by utilizing the lead terminals of the high-voltage components, the production process is very difficult and the number of the process is large. Further, since the components are disposed at the side surface, there arises a problem that it is very difficult to cool the high-voltage components.

This invention is made to solve the problems of the related art, and an object of this invention is to provide a transformer unit which can reduce the number of production processes and improve the cooling efficiency.

### Means for Solving the Problem

In order to solve the problem, a transformer unit of the present invention includes: a transformer which is mounted on a printed board, and which includes a bobbin around which at least a primary winding and a secondary winding are wound and a core which is inserted into a center of the bobbin; a component holding portion configured to hold a component at an outer peripheral portion except for a mount side to be mounted on the printed board; and a voltage doubler rectifying circuit which is provided at the component holding portion and which is configured to rectify a high-frequency high voltage applied from the secondary winding, and the secondary winding is connected to a lead terminal of a high-voltage component constituting the voltage doubler rectifying circuit via tension absorbing means provided at the bobbin without intervening a rib provided on the bobbin.

### Advantages of the Invention

This invention can provide the high-frequency heating device which can improve the productivity of a transformer unit integrated with high-voltage components and also improve the heat radiation efficiency of the respective high-voltage components.

### BRIEF DESCRIPTION OF THE DRAWINGS

FIG. 1 is diagrams showing the structures of transformer units according to the first and second embodiments of this invention, in which FIG. 1(a) is a side view of the transformer unit and FIG. 1(b) is a bottom view of the transformer unit.

FIG. 2 is diagrams showing the structures of transformer unit of a related art and the transformer unit of this invention, in which FIG. 2(a) is the diagram showing the structure of the transformer unit of the related art and FIG. 2(b) is the diagram showing the structure of the transformer unit according to the third embodiment of this invention.

FIG. 3 is a diagram showing the soldering structure of the transformer unit according to the fifth embodiment of this invention.

FIG. 4 is the circuit diagram of a high-frequency heating device of a related art.

### MODE FOR CARRYING OUT THE INVENTION

A first invention provides a transformer unit including: a transformer which is mounted on a printed board, and which includes a bobbin around which at least a primary winding and a secondary winding are wound and a core which is inserted into a center of the bobbin; a component holding portion configured to hold a component at an outer peripheral portion except for a mount side to be mounted on the printed board; and a voltage doubler rectifying circuit which is provided at the component holding portion and which is configured to rectify a high-frequency high voltage applied from the secondary winding, wherein the secondary winding is connected to a lead terminal of a high-voltage component constituting the voltage doubler rectifying circuit via tension absorbing means provided at the bobbin without intervening a rib provided on the bobbin.

A second invention provides the transformer unit according to the first invention, wherein the lead terminal of the high-voltage component is processed in an L-shape so as to be in parallel to a winding nozzle configured to automatically wind the secondary winding.

A third invention provides the transformer unit according to the first or second invention, wherein the secondary winding is connected to the lead terminal of the high-voltage component by soldering.

A fourth invention provides the transformer unit according to the third invention, wherein connection between the high-voltage components is performed by mutually electrically connecting the lead terminals thereof via a plate-shaped connection terminal also serving as a heat radiation plate, and the plate-shaped connection terminal is also soldered, thereby improving heat radiation efficiency.

Hereinafter, the embodiments of this invention will be explained with reference to drawings. These embodiments are mere examples realizing this invention and this invention contains various modifications changed within the configurations described in claims.

### First Embodiment

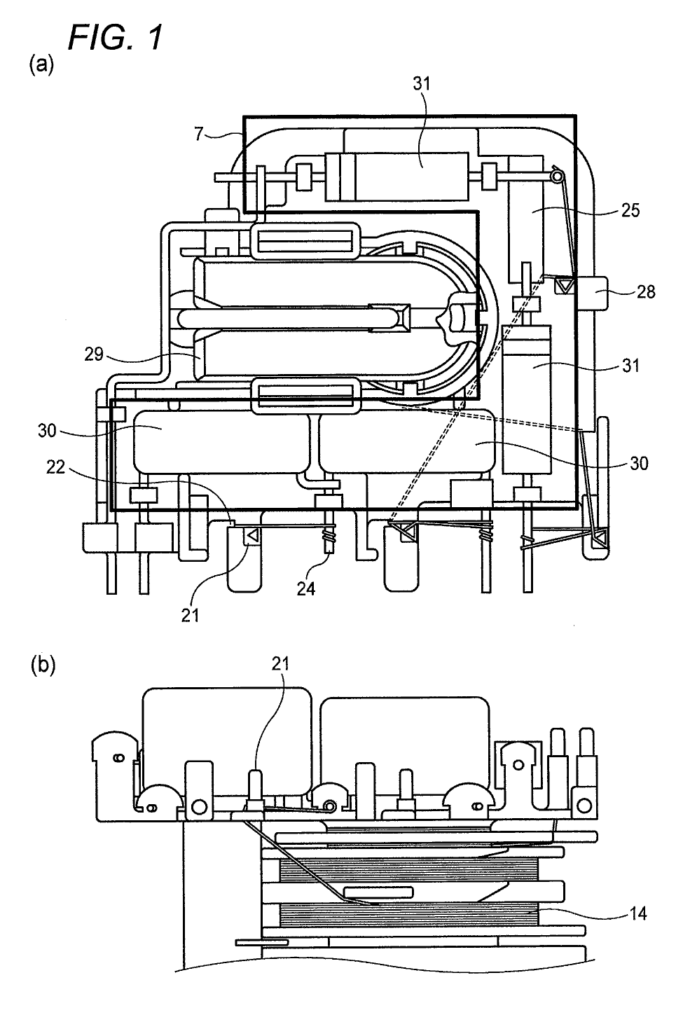

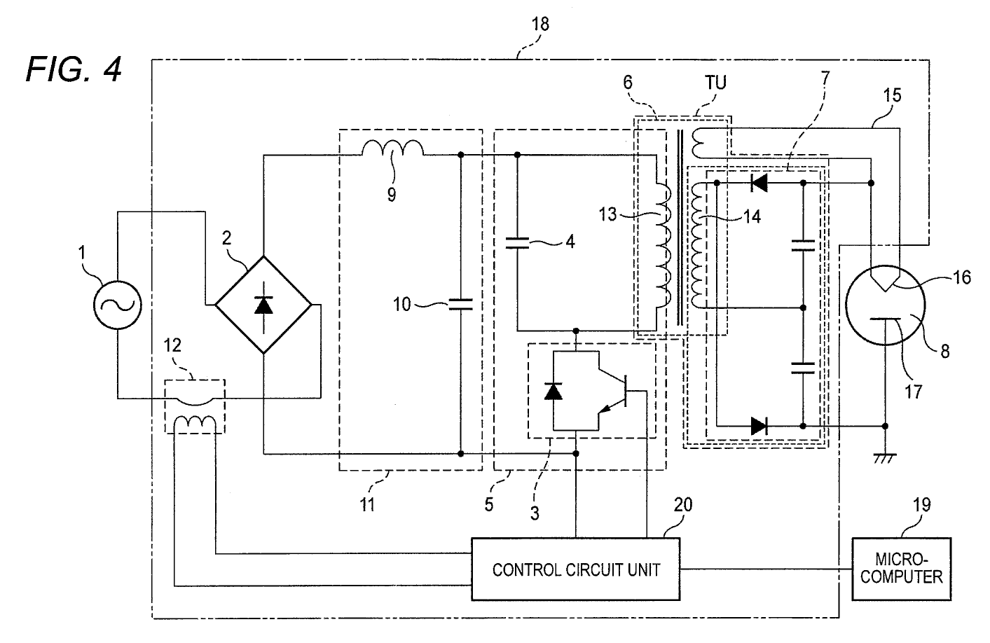

FIG. 1 is diagrams showing the structure of a transformer unit according to the first embodiment of this invention. FIG. 1(a) is a side view of the transformer unit showing that a voltage doubler rectifying circuit 7 is disposed on a bobbin 28. FIG. 1(b) is a constitutional diagram of the transformer unit seen from the lower surface side thereof. This figure shows the winding end portion of a secondary winding 14. As shown by the circuit diagram of the high-frequency heating device including the inverter-type power supply shown in FIG. 4, the winding end portion and the winding start portion of the secondary winding 14 are connected to the center point of high-voltage capacitors 30 and the center point of high-voltage diodes 31 that constitutes the voltage doubler rectifying circuit 7, respectively. Thus, the voltage doubler rectifying circuit 7 can perform the full-wave rectification. Accordingly, the transformer unit constituted so as to hold the voltage doubler rectifying circuit 7 on the bobbin 28 is required to connect the lead terminals of the high-voltage components with the secondary winding 14.

The connection between the center point of the high-voltage capacitors 30 and the secondary winding 14 is performed by the assembling from the lower surface to the side surface as shown in FIG. 1. That is, a tension is absorbed by a cut portion 22 provided at the bobbin so as not to apply a large tension to the lead terminals 24 of the high-voltage components. Therefore, although the high-frequency heating device including the inverter-type power supply of the related art is quired to wind the secondary winding 14 around a rib 21 provided at the bobbin 28 and hold thereto at the time of connecting the secondary winding 14 to the lead terminals of the high-voltage components, this embodiment can eliminate such the procedure. Thus, since the connection between the secondary winding 14 and the lead terminals performed by reducing the number of processes can be realized, it is possible to manufacture the transformer units with improved productivity.

### Second Embodiment

The second embodiment of this invention will be explained also with reference to FIG. 1. In the related art, the center point of the high-voltage capacitors 30 and the secondary winding 14 are connected via a relay terminal (not shown) provided separately. However, the related art additionally requires the cost of the relay terminal itself and further a process of welding the end portion of the secondary winding 14 to the lead terminal 24 via the relay terminal. In this case, there also arises a problem in the reliability of the welding. According to the second embodiment, these problems are eliminated in a manner that the connection between the secondary winding 14 and the lead terminal 24 of the high-voltage capacitor 30 is realized by the direct winding. That is, since this embodiment simply employs a process of directly winding the end portion of the secondary winding 14 around the lead terminal 24 of the high-voltage component, the connection with high reliability can be realized without requiring additional cost nor process.

### Third Embodiment

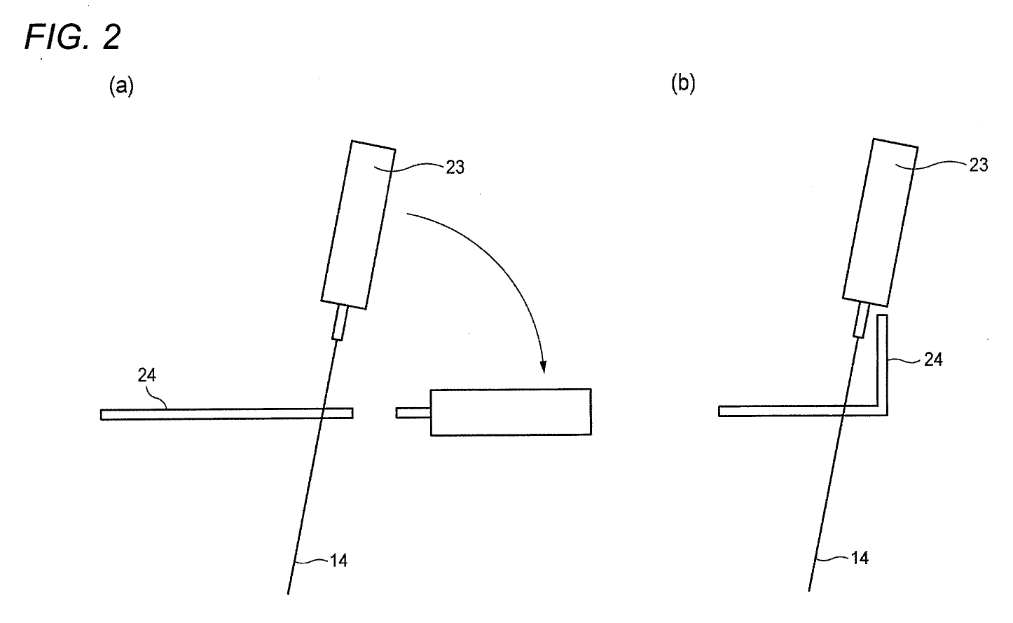

FIG. 2 is diagrams showing the structure of the transformer unit of the related art and the structure of the transformer unit according to the third embodiment of this invention, and in particular, each showing the process of connecting the secondary winding 14 and the voltage doubler rectifying circuit 7 in each of these transformer units. FIG. 2(a) is a diagram for explaining the process of connecting the secondary winding 14 and the voltage doubler rectifying circuit 7 in the transformer unit of the related art, and FIG. 2(b) is a diagram showing the process of connecting the secondary winding 14 and the voltage doubler rectifying circuit 7 in the transformer unit of the third embodiment of this invention. The secondary winding 14 is wound by an automatic machine, and the winding start portion and the winding end portion thereof are also wound respectively around the lead terminals 24 of the high-voltage components by the automatic machine. That is, the winding process of the secondary winding 14 is performed in a manner that the winding nozzle 23 supplying the secondary winding 14 moves around the transformer unit to hook the winding on the cut portion 22, for example, without winding around the rib on the bobbin 28 nor being wound around the rib. The movement of the winding nozzle 23 and the swinging thereof by 90 degrees largely influence on the productivity (number of processes) (see FIG. 2(a)).

In this invention, as shown in FIG. 2(b), since the lead terminal 24 of the high-voltage component is processed in an L-shape, the lead terminal becomes in parallel to the moving direction of the winding nozzle 23 of the automatic machine. Thus, this invention can eliminate the process of swinging the winding nozzle 23 itself by 90 degrees to wind around the lead terminal 24, and hence the winding nozzle can wind the winding around the lead terminal 24 in its original state. Therefore, it is possible to manufacture the transformer unit with high productivity by reducing the number of processes.

### Fourth Embodiment

This invention according to the fourth embodiment employs the soldering as the method of connecting the secondary winding 14 and the respective high-voltage components. That is, as explained in the second embodiment as the assembling method having the least number of processes, this embodiment employs the soldering in order to effectively utilize the method of directly winding the end portion of the secondary winding 14 around the lead terminals of the respective high-voltage components.

The soldering is advantageous in a point that a finished product where a failure occurs can be repaired easily as compared with the fusing of the related art. That is, the disconnection arises mostly as the failure of the fusing method. In this case, it is almost impossible to repair the products in the case where the yield rate reduces. In contrast, although the solder shortage is supposed as the failure of the soldering, the product can be repaired by the additional soldering in that case. The soldering is also effective clearly in an ecological view point such as cost of the material to be destroyed.

### Fifth Embodiment

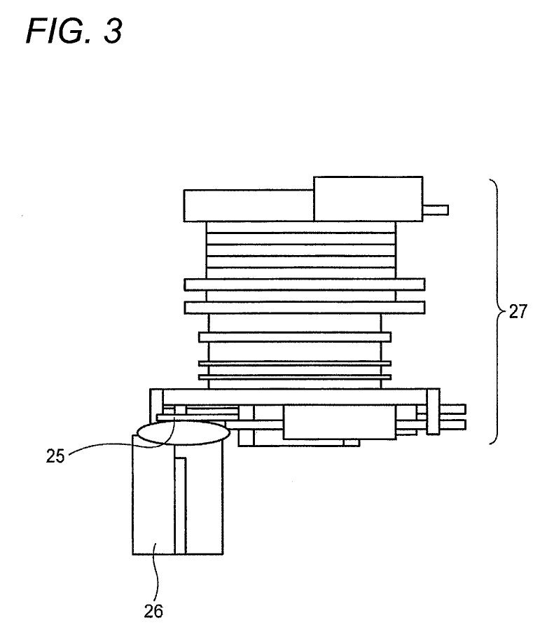

FIG. 3 shows the configuration of the fifth embodiment of this invention. Although radiation plates 25 are used for the connection between the high-voltage components, these plates are not enough for obtaining the sufficient heat radiation efficiency. As explained above, this invention according to the fourth embodiment employs the soldering as the method of connecting the secondary winding 14 and the voltage doubler rectifying circuit 7. In this embodiment, the radiation plates 25 are also soldered by employing the soldering of the fourth embodiment to thereby increase the heat radiation capacity. As shown in FIG. 3, in the transformer unit 27, portions (connection points between the secondary winding 14 and the high-voltage components constituting the voltage doubler rectifying circuit 7) to be soldered each bent down vertically from the upper portion of a solder pot 26 are each soldered in a pin point manner (locally). In this invention, the radiation plates 25 are also soldered at the same timing where the secondary winding 14 and the voltage doubler rectifying circuit 7 are soldered by using the solder in a jet flow state. Since the processing is performed at this timing, it is also advantageous that none of special processes and jig are required.

Although the various embodiments are explained with reference to the drawings, it is matter of course that the information display device according to this invention is not limited thereto. It will be apparent for those skilled in the art that various changes or modifications may be made within a range of the scope of claims. It will be recognized that these changes or modifications of course belong to the technical range of this invention.

This invention is based on Japanese Patent Application (Japanese Patent Application No. 2010-001683) filed on Jan. 7, 2010, the content of which is incorporated herein by reference.

### INDUSTRIAL APPLICABILITY

As described above, according to the transformer unit of this invention, the number of production processes can be reduced and the heat radiation efficiency of the high-voltage components can be improved. Therefore, the transformer units each excellent in the reliability and the productivity can be supplied in large quantities.

### DESCRIPTION OF REFERENCE SIGNS

7 Voltage Doubler Rectifying Circuit
13 Primary Winding
14 Secondary Winding
18 Inverter-type Power Supply
22 Cut Portion
23 Winding Nozzle
24 Lead Terminal
25 Radiation Plate
26 Solder Pot
27 Transformer Unit
28 Bobbin

1. A transformer unit comprising:
a transformer which is mounted on a printed board, and which comprises: a bobbin around which at least a primary winding and a secondary winding are wound; and a core which is inserted into a center of the bobbin; and
a component holding portion configured to hold a component at an outer peripheral portion except for a mount side to be mounted on the printed board,
wherein the transformer unit further comprises a voltage doubler rectifying circuit which is provided at the component holding portion and which is configured to rectify a high-frequency high voltage applied from the secondary winding, and
wherein the secondary winding is connected to a lead terminal of a high-voltage component constituting the voltage doubler rectifying circuit via tension absorbing means provided at the bobbin by directly winding the secondary winding around the lead terminal and also by soldering.

2. The transformer unit according to claim 1,
wherein the lead terminal of the high-voltage component is processed in an L-shape so as to be in parallel to a winding nozzle configured to automatically wind the secondary winding.

3. (canceled)

4. The transformer unit according to claim 1,
wherein connection between the high-voltage components is performed by mutually electrically connecting the lead terminals thereof via a plate-shaped connection terminal also serving as a heat radiation plate, and the plate-shaped connection terminal is also soldered, thereby improving heat radiation efficiency.
